(19) United States
(12) Patent Application Publication
(10) Pub. No.: US 2022/0224661 A1
(43) Pub. Date: Jul. 14, 2022

(54) ELECTRONIC DEVICE FOR RECEIVING OR TRANSMITTING RCS DATA AND OPERATION METHOD OF ELECTRONIC DEVICE

(71) Applicant: Samsung Electronics Co., Ltd., Gyeonggi-do (KR)

(72) Inventors: Kyuhyun KIM, Gyeonggi-do (KR); Minsun KIM, Gyeonggi-do (KR); Yeungseob SHIN, Gyeonggi-do (KR); Seongjun YIM, Gyeonggi-do (KR); Jeongyong KIM, Gyeonggi-do (KR)

(21) Appl. No.: 17/221,889

(22) Filed: Apr. 5, 2021

(30) Foreign Application Priority Data
Jan. 13, 2021 (KR) 10-2021-0004912

(51) Int. Cl. H04L 12/58; H04W 4/12

(52) U.S. Cl. CPC H04L 51/063; H04W 4/12; H04L 51/38; H04L 51/10; H04L 51/22; H04L 51/36

(57) ABSTRACT

An electronic device and an electronic device operation method according to certain embodiments are provided. The electronic device may include: a memory configured to store a first message exchanged with an external electronic device; a wireless communication circuit; and a processor, wherein the processor is configured to: perform a registration procedure with a rich communication service (RCS) server; receive a user input for activating a specific function related to a message exchanged with the external electronic device; generate a second message including identification information of the specific function, identification information of a first message related to the specific function, at least a part of the first message, and/or input data; and transmit the second message to the external electronic device through the RCS server. In addition, certain embodiments may be possible.

### CROSS-REFERENCE TO RELATED APPLICATION(S)

This application is based on and claims priority under 35 U.S.C. 119 to Korean Patent Application No. 10-2021-0004912, filed on Jan. 13, 2021, in the Korean Intellectual Property Office, the disclosure of which is herein incorporated by reference in its entirety.

### BACKGROUND

### 1) Field

Certain embodiments relate to an electronic device and an electronic device operation method and, more particularly, to an electronic device for receiving data from an RCS server or transmitting the same.

### 2) Description of Related Art

To meet the increased demand for wireless data traffic since deployment of 4G communication systems, efforts have been made to develop an improved 5G or pre-5G communication system. Therefore, the 5G or pre-5G communication system is also called a “Beyond 4G Network” or a “Post LTE System”.

As new generation communication systems become deployed, it becomes important that features of legacy communication systems are usable.

The above information is presented as background information only to assist with an understanding of the disclosure. No determination has been made, and no assertion is made, as to whether any of the above might be applicable as prior art with regard to the disclosure.

### SUMMARY

An electronic device according to various embodiments comprises a memory configured to store one or more first messages exchanged with an external electronic device; a wireless communication circuit; and a processor, wherein the processor is configured to: register with a rich communication service (RCS) server; receive a user input activating a specific function related to a particular one of the one or more first messages; generate a second message including identification information of the specific function, identification information of the particular one of the one or more first messages, at least a part of the particular one of the one or more first messages, and input data; and transmit the second message to the external electronic device through the RCS server.

An electronic device according to certain embodiments comprises: a memory configured to store at least one first message exchanged with an external electronic device; a wireless communication circuit; and a processor, wherein the processor is configured to: register with a rich communication service (RCS) server; receive a second message including identification information of a specific function, identification information of a particular one of the at least one first message, at least part of the first message and data; in response to identifying that the electronic device supports the specific function based on the identification information of the specific function, identify the particular one of the at least one first message stored in the memory based on the identification information of the particular one of the at least one first message; and process the second message to display the identified first message and the data together.

An operation method of an electronic device comprises: registering with a rich communication service (RCS) server; receiving a user input for activating a specific function related to a message exchanged with an external electronic device; generating a second message including identification information of the specific function, identification information of a particular one of the one or more first messages related to the specific function, at least a part of the particular one of the one or more first messages, and input data; and transmitting the second message to the external electronic device through the RCS server.

### BRIEF DESCRIPTION OF THE DRAWINGS

For a more complete understanding of the disclosure and its advantages, reference is now made to the following description taken in conjunction with the accompanying drawings, in which like reference numerals represent like parts:

FIG. 1 is a block diagram of an electronic device according to certain embodiments;

FIG. 2 is a block diagram of a program according to certain embodiments;

FIG. 3 illustrates a first electronic device, a second electronic device, and/or an RCS server according to certain embodiments;

FIG. 4 is a block diagram of a first electronic device according to certain embodiments;

FIG. 5 is a block diagram of a second electronic device according to certain embodiments;

FIG. 6A illustrates a format of messages exchanged between a first electronic device and a second electronic device according to certain embodiments;

FIG. 6B illustrates a format of messages exchanged between a first electronic device and a second electronic device according to certain embodiments;

FIG. 6C illustrates a format of messages exchanged between a first electronic device and a second electronic device according to certain embodiments;

FIG. 7A illustrates an embodiment in which messages exchanged among a first electronic device, a second electronic device, and a third electronic device are displayed according to certain embodiments;

FIG. 7B illustrates an embodiment in which messages exchanged among a first electronic device, a second electronic device, and a third electronic device are displayed according to certain embodiments;

FIG. 7C illustrates an embodiment in which messages exchanged among a first electronic device, a second electronic device, and a third electronic device are displayed according to certain embodiments;

FIG. 8A illustrates an embodiment in which messages exchanged among a first electronic device, a second electronic device, and a third electronic device are displayed according to certain embodiments;

FIG. 8B illustrates an embodiment in which messages exchanged among a first electronic device, a second electronic device, and a third electronic device are displayed according to certain embodiments;

FIG. 8C illustrates an embodiment in which messages exchanged among a first electronic device, a second electronic device, and a third electronic device are displayed according to certain embodiments;

FIG. 9A illustrates an embodiment in which messages exchanged among a first electronic device, a second electronic device, and a third electronic device are displayed according to certain embodiments;

FIG. 9B illustrates an embodiment in which messages exchanged among a first electronic device, a second electronic device, and a third electronic device are displayed according to certain embodiments;

FIG. 9C illustrates an embodiment in which messages exchanged among a first electronic device, a second electronic device, and a third electronic device are displayed according to certain embodiments;

FIG. 10A illustrates an embodiment in which messages exchanged among a first electronic device, a second electronic device, and a third electronic device are displayed according to certain embodiments;

FIG. 10B illustrates an embodiment in which messages exchanged among a first electronic device, a second electronic device, and a third electronic device are displayed according to certain embodiments;

FIG. 10C illustrates an embodiment in which messages exchanged among a first electronic device, a second electronic device, and a third electronic device are displayed according to certain embodiments;

FIG. 11 is an operation flowchart illustrating an operation method of an electronic device according to certain embodiments; and

FIG. 12 is an operation flowchart illustrating an operation method of an electronic device according to certain embodiments.

### DETAILED DESCRIPTION

The 5G communication system is considered to be implemented in higher frequency (mmWave) bands, e.g., 60 GHz bands. This allows higher data rates. Beam forming is used to to decrease propagation loss of the radio waves and increase the transmission distance. The beamforming, massive multiple-input multiple-output (MIMO), full dimensional MIMO (FD-MIMO), array antenna, and analog beam forming, large scale antenna techniques are discussed in 5G communication systems.

Fourth-generation mobile communication and fifth-generation mobile communication have been designed to be able to perform packet-based message exchange services. Rich communication service (RCS) service is among the packet-based message exchange services.

The RCS service may provide enriched calling where multimedia files (for example, moving images or pictures) can be shared during a call. Another feature is an enhanced phonebook. The enhanced phonebook allows information regarding a communication counterpart registered in the phonebook to be acquired in real time. Another function is enriched messaging. Enriched message allows files to be shared during chatting.

The RCS service may be implemented through an RCS server for managing the RCS service. A receiving electronic device and a transmitting electronic device may establish a session for exchanging data through the RCS server.

In order to perform a specific RCS-based function (for example, a replying function, an emoticon transmission function, a data transmission function, and/or a data transmission canceling function), the receiving electronic device and the transmitting electronic device both need to support the specific function.

In order to activate the specific function, the receiving electronic device and/or the transmitting electronic device may identify from the RCS server, whether the counterpart electronic device supports the specific function. The procedure of identifying whether the counterpart electronic device supports the specific function may increase the latency time necessary to activate the specific function.

Additionally, since the message format transmitted to the counterpart electronic device is changed according to whether the counterpart electronic device supports the specific function, the latency time may increase when changing the message format and processing the message to be transmitted according to the changed message format.

Certain embodiments may decrease latency that occurs during RCS.

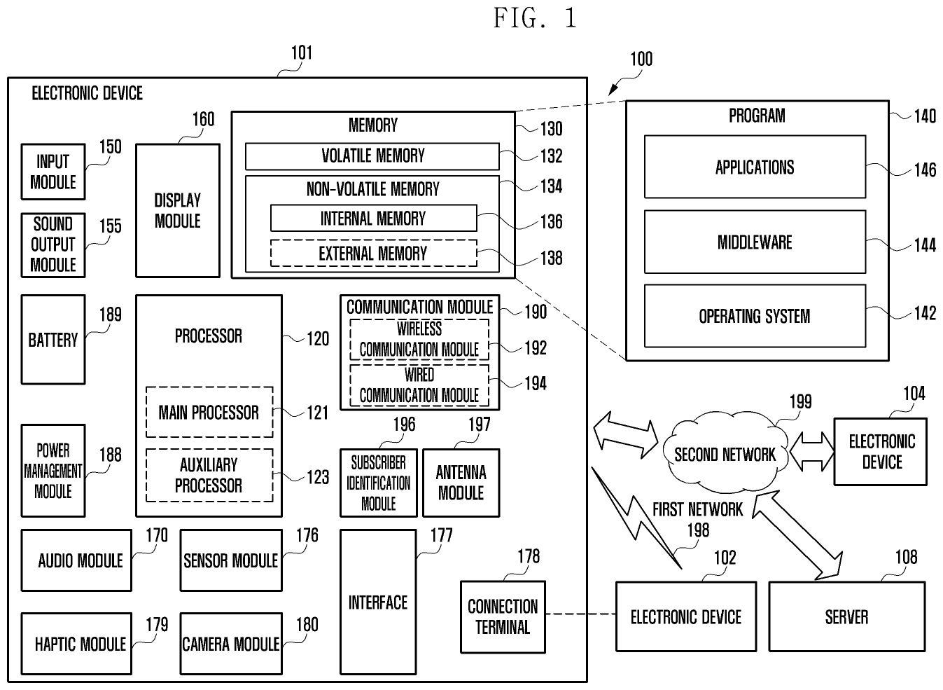

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module(SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The term “processor” shall be understood to include both the singular and plural contexts, and thus “processor” shall be understood to mean “one or more processors.”

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

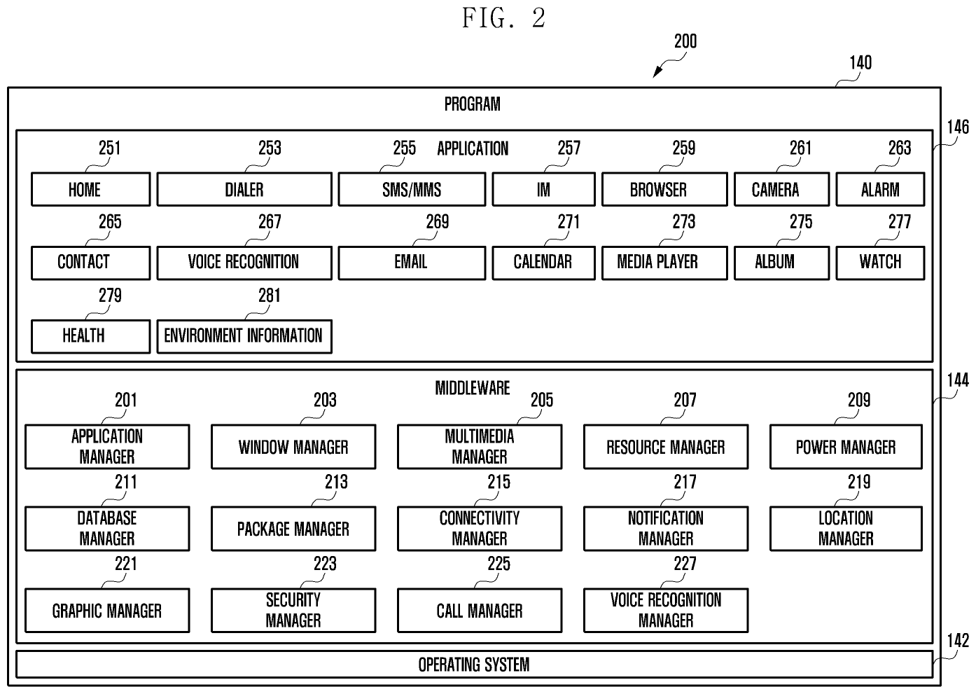

FIG. 2 is a block diagram 200 illustrating the program 140 according to certain embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130.The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application.

According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display module or a camera module of the external electronic device). The device management application, additionally or alternatively, may support installation, delete, or update of an application running on the external electronic device.

The electronic device 101 and another electronic device 102 may communicate using RCS service. RCS service may provide enriched calling where multimedia files (for example, moving images or pictures) can be shared during a call. Another feature is an enhanced phonebook. The enhanced phonebook allows information regarding a communication counterpart registered in the phonebook to be acquired in real time. Another function is enriched messaging. Enriched message allows files to be shared during chatting.

The RCS service may be implemented through an RCS server 300 for managing the RCS service. A receiving electronic device and a transmitting electronic device may establish a session for exchanging data through the RCS server.

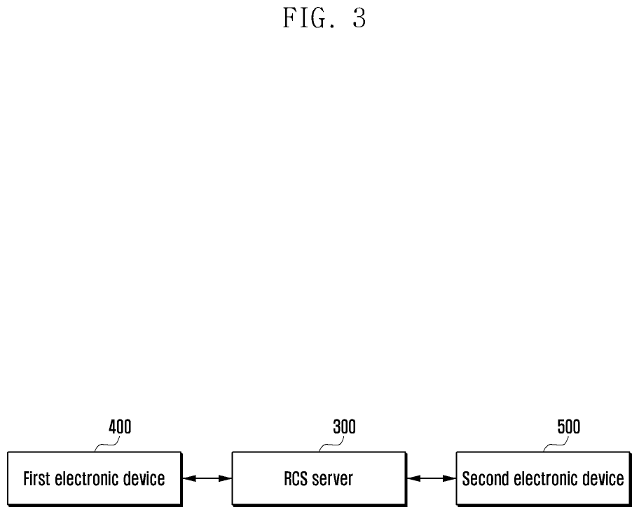

FIG. 3 illustrates a first electronic device 400, a second electronic device 500, and an RCS server 300 according to certain embodiments.

RCS includes numerous functions, some of which might not be supported by the first or second electronic device. A problem can occur if the first electronic device 400 transmits a message according to a specific function not supported by the second electronic device 500. The second electronic device 500 may discard the message, or not process it. While the first electronic device 400 can determine whether the second electronic device 500 supports the specific function by transmitting a query, this procedure is time consuming and detracts from the user experience. Accordingly, certain embodiments include transmitting messages a format that causes processing a specific function regardless of whether the receiving electronic device supports it.

The rich communication service (RCS) server 300 may perform message exchange between electronic devices registered in the RCS server 300. A rich communication service (RCS) is a packet data-based communication service, and may refer to a communication service for transmitting or receiving various contents including text messages, images, videos, and voices. The RCS is a communication service defined after a short message service (SMS) for transmitting or receiving text messages having a designated size or less, and a multimedia messaging service (MIMS) for transmitting or receiving messages including contents and/or text messages having a designated size or more.

The first electronic device 400 and/or the second electronic device 500 may establish a session for data transmission or reception to or from the RCS server 300 by using a communication scheme (e.g., short-range wireless communication or cellular communication). The first electronic device 300 and/or the second electronic device 500 may receive data from the RCS server 300 or transmit data to the RCS server 300 through the established session. The RCS server 300 may also receive data transmitted by an external server (not shown), and may transmit data to the first electronic device 400 and/or the second electronic device 500 through the session established between the RCS server 300 and the first electronic device 400 and/or the second electronic device 500. The data exchanged between the RCS server 300 and the first electronic device 400 and/or the second electronic device 500 may include data for session establishment, data for session management, and/or a message including contents.

The first electronic device 400 and/or the second electronic device 500 may register with the RCS server 300 through the established session. Registering the first electronic device 400 and/or the second electronic device 500 in the RCS server 300 may include registering addresses of the first electronic device 400 and/or the second electronic device 500 in the RCS server 300. The addresses can be those which the first electronic device 400 and/or the second electronic device 500 uses to receive data from the RCS server 300 or transmit data to the RCS server 300. The address of the first electronic device 400 and/or the second electronic device 500 may be their IP addresses.

The first electronic device 400 and/or the second electronic device 500 may exchange messages through the RCS server 300. In the following description, for convenience of explanation, it is assumed that the first electronic device 400 transmits messages and the second electronic device 500 receives messages. It is noted, however, that the first electronic device 400 can also perform message reception and the second electronic device 500 can also perform message transmission. Additionally, both electronic devices 400 and 500 can perform both.

The first electronic device 400 may support a specific function related to messages exchanged with the second electronic device 500. The specific function may include, for example, replying to messages that have been previously exchanged; deleting, on the second electronic device 500, at least one message among messages that have been previously exchanged; a adding data (e.g., emoticons) relating to messages that have been previously exchanged; and/or a function of deleting data (e.g., emoticons) relating to messages that have been previously exchanged, among others. The specific function related to messages exchanged with the second electronic device 500 may be executed when the second electronic device 500 supports the specific function.

In order to identify whether the second electronic device 500 supports a specific function related to messages exchanged with the second electronic device 500, the first electronic device 400 may transmit a query to the RCS server 300 whether the second electronic device 500 supports the specific function. Based on data transmitted by the RCS server 300, the first electronic device 400 may identify whether the second electronic device 500 supports the specific function. When the second electronic device 500 supports the specific function, the first electronic device 400 may transmit a message including data according to the specific function and information (e.g., a reply or emoticon) input by a user to the second electronic device 500 through the RCS server 300.

Referring to the embodiment described above, when the second electronic device 500 supports a specific function, the first electronic device 400 may perform the specific function. When the second electronic device 500 does not support a specific function, the first electronic device 400 may not transmit data according to the specific function to the second electronic device 500. When the second electronic device 500 does not support the specific function and receives a message according to the specific function, the second electronic device 500 may discard it. Even if the message is received, when the second electronic device 500 does not support the specific function, it may not process a message. This results in an inconvenience.

Hereinafter, an embodiment, in which messages are exchanged using a message format implemented to process a specific function regardless of whether an electronic device (e.g., the second electronic device 500) receiving a message supports a specific function related to the message, will be described.

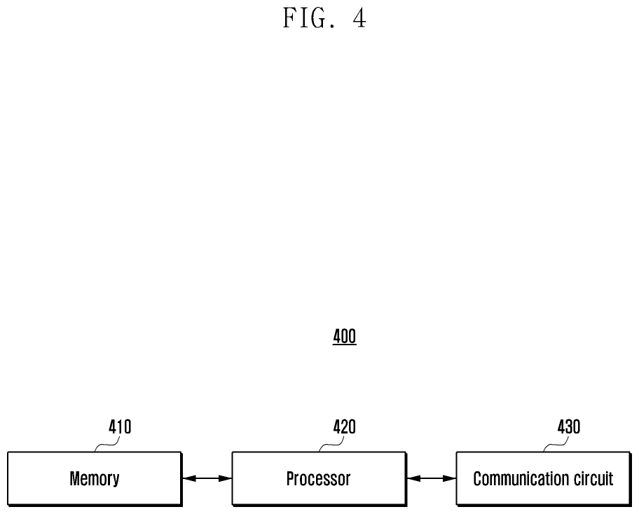

FIG. 4 is a block diagram of a first electronic device according to certain embodiments.

Referring to FIG. 4, a first electronic device 400 according to certain embodiments may include a memory 410 (e.g., the memory 130 of FIG. 1), and a processor 420 (e.g., the processor 120 of FIG. 1), and/or a communication circuit 430 (e.g., the wireless communication module 192 of FIG. 1).

The memory 410 may store one or more first messages that were previously exchanged between the first electronic device 400 and the second electronic device (e.g., the second electronic device 500 of FIG. 3). Each of the stored one or more first messages may have different identification information. The first messages may include messages exchanged between the first electronic device 400 and the second electronic device 500 before transmission or reception of the second message. The memory 410 may store data for which identification information is mapped to the one or more first messages.

The communication circuit 430 may perform data transmission or reception through wireless communication. The communication circuit 430 may be a communication circuit supporting one of a short-range wireless communication (such as Wi-Fi) or a cellular communication method (transmitting or receiving through a base station). . For example, cellular communication may denote 4G mobile communication (long term evolution (LTE)) or 5G mobile communication (new radio (NR)).

The processor 420 may control the communication circuit 430 to perform a rich communication service (RCS). According to an embodiment, the processor 420 may control the communication circuit 430 to transmit data to perform a registration procedure with an RCS server (e.g., the RCS server 300 of FIG. 3) or may control the communication circuit 430 to receive data from the RCS server 300. The processor 420 may transmit a message to the second electronic device 500 or receive a message transmitted by the second electronic device 500, in response to completing of the registration procedure with the RCS server 300.

An RCS application (not shown) may be executed on the processor 420. The RCS application may be an application that processes messages exchanged between the RCS server 300 and the first electronic device 400 and performs a function of displaying or outputting processed data. The RCS application may provide a user interface capable of providing first messages to a user. For example, the RCS application may provide an interface that provides a user with a message received from the RCS server 300 and/or a message transmitted to the second electronic device 500 through the RCS server 300, and may provide an interface through which a message, which is transmitted to the second electronic device 500 through the RCS server 300, is input.

The processor 420 may receive a user input for inputting a message including data to be transmitted to the second electronic device 500. The processor 420 may control the communication module 430 to transmit the input message to the second electronic device 500 through the RCS server 300.

The processor 420 may receive, through a user interface, a user input for activating a specific function related to a message exchanged with the second electronic device 500. The specific function related to a message exchanged with the second electronic device 500 may include various functions such as: a function of replying to messages that have been previously exchanged between the first electronic device 400 and the second electronic device 500; a function of deleting, on the second electronic device 500, at least one message among messages that have been previously exchanged between the first electronic device 400 and the second electronic device 500; a function of adding data (e.g., emoticons) relating to messages that have been previously exchanged between the first electronic device 400 and the second electronic device 500; and/or a function of deleting data (e.g., emoticons) relating to messages that have been previously exchanged between the first electronic device 400 and the second electronic device 500.

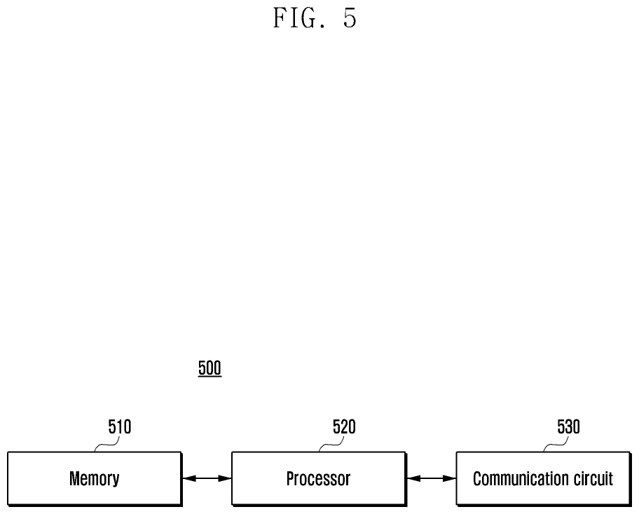

According to certain embodiments, the processor 420 may generate the second message including data for execution of a specific function and data (e.g., contents desired to be transmitted by a user) input through a user interface regardless of whether the second electronic device 500 supports a specific function, and may control the communication module 430 to transmit the second message to the second electronic device 500. When the second electronic device 500 supports a specific function, the second electronic device 500 having received the second message may identify the data for execution of the specific function, and may process the second message based on the identified data. When the second electronic device 500 does not support a specific function, the second electronic device 500 may output data, which is included in the second message and input through the user interface. The operation of the second electronic device 500 will be described later with reference to FIG. 5.

According to certain embodiments, in response to receiving a user input for activating a specific function, the processor 420 may generate the second message including identification information of a specific function, identification information of a first message related to a specific function, at least a part of the first message, and/or input data. The second message may be transmitted to the second electronic device 500 through the RCS server 300.

According to certain embodiments, the processor 420 may identify identification information of the specific function corresponding to a user input for activating a specific function. For example, when the specific function is a function of replying to a first message, the processor 420 may identify identification information corresponding to the reply function and add the identified identification information to a second message. For another example, if the specific function is a function of transmitting a designated emoticon of the first message, the processor 420 may identify identification information corresponding to the emoticon function and add the identified identification information to the second message. For another example, when the specific function is a function of sharing the first message stored in the memory 410, the processor 420 may identify identification information corresponding to the sharing function and add the identified identification information to the second message. For another example, when the specific function is a function of deleting a message stored in the second electronic device 500, the processor 420 may identify identification information corresponding to the delete function and add, to the second message, the identified identification information and/or identification information of a message to be deleted.

According to certain embodiments, the processor 420 may receive, through a user interface, data (e.g., text, an image and/or video) to be transmitted to the second electronic device 500 and a user input for activating a specific function, and may generate the second message such that input data is included therein. When the specific function is a function of replying to the first message, the processor 420 may add data input through the user interface to the second message. For another example, when the specific function is a function of transmitting a designated emoticon of the first message, the processor 420 may add information indicating an emoticon selected through a user input to the second message. For another example, when a specific function is a function of sharing a first message, the processor 420 may upload a first message to be shared to an external server, may identify an address of the external server (not shown) in which the first message to be shared is stored, and may add the address to the second message.

According to certain embodiments, in response to a user input for activating a specific function, the processor 420 may identify identification information of a first message related to the specific function. The first electronic device 400 and/or the second electronic device 500 may store a first message exchanged therebetween, and identification information of the first message stored in the first electronic device 400 may be the same as identification information of the first message stored in the second electronic device 500. The second electronic device 500 may perform a specific function based on identification information of the first message. When the specific function is a function of replying to the first message, the processor 420 may identify the first message to which a reply is to be provided, and may add identification information of the identified first message to the second message. For another example, when the specific function is a function of transmitting a designated emoticon of the first message, the processor 420 may identify the first message to which an emoticon is to be transmitted, and may add identification information of the identified first message to the second message.

According to certain embodiments, the processor 420 may generate the second message such that at least a part of the first message related to a specific function is included therein. The processor 420 may allow at least a part of the first message to be included in the second message at the time of generation thereof, and thus may allow a user of the second electronic device 500 to identify a message related to the specific function even when the electronic device (e.g., the second electronic device 500) having received the second message does not support the specific function.

According to certain embodiments, the processor 420 may identify the size of the first message, and when the size of the first message is less than or equal to a designated size, may generate a second message such that all the first messages are included therein. The processor 420 may generate, in response to the size of the first message being equal to or greater than (or exceeding) the designated size, the second message such that at least a part of the first message is included therein. The processor 420 may extract at least a part of data from the first message. The processor 420 may extract at least a part of the first message through various extraction methods (e.g., a method of extracting a front part from the first message, a method of extracting a latter part from the first message, and a method of extracting a part including the most repeated word), and may add the extracted part to the second message.

According to certain embodiments, the second message may include at least a part of the first message and input data. A delimiter predetermined between the first electronic device 400 and the second electronic device 500 may exist between the at least a part of the first message and the input data. When the second electronic device 500 supports a specific function, the second electronic device 500 may process the second message in a manner of outputting input data distinguished by the delimiter. When the second electronic device 500 does not support a specific function, the second electronic device 500 may process the second message such that at least a part of the first message, a delimiter, and/or input data are all output.

Through the method described above, the first electronic device 400 may generate and transmit a second message that can be processed by the second electronic device 500 without identifying whether the second electronic device 500 supports a specific function (or regardless of whether the second electronic device 500 supports a specific function). Therefore, when the second electronic device 500 that does not support a specific function receives the second message, the second electronic device 500 may display (or output) the first message related to the specific function and data input by a user of the first electronic device 400, in a similar manner of supporting the specific function.

FIG. 5 is a block diagram of a second electronic device according to certain embodiments.

Referring to FIG. 5, a second electronic device 500 according to certain embodiments may include a memory 510 (e.g., the memory 130 of FIG. 1), and a processor 520 (e.g., the processor 120 of FIG. 1), and/or a communication circuit 530 (e.g., the wireless communication module 192 of FIG. 1).

According to certain embodiments, the memory 510 may store a one or more first messages, previously exchanged between the first electronic device 400 and the second electronic device (e.g., the second electronic device 500 of FIG. 3). Each of the stored one or more first messages may have different identification information. The memory 510 may store data for which identification information is mapped to at least one first message.

According to certain embodiments, the communication circuit 530 may perform data transmission or reception through wireless communication. The communication circuit 530 may be a communication circuit supporting one of a short-range wireless communication method or a cellular communication method. Short-range wireless communication may denote wireless communication other than cellular communication. For example, short-range wireless communication may denote a communication method for transmitting or receiving data through various types of wireless networks including Wi-Fi. Cellular communication may denote communication for transmitting or receiving data through a base station. For example, cellular communication may denote 4G mobile communication (long term evolution (LTE)) or 5G mobile communication (new radio (NR)).

The processor 520 may control the communication circuit 530 to perform a rich communication service (RCS). According to an embodiment, the processor 520 may control the communication circuit 530 to transmit data to perform a registration procedure with an RCS server (e.g., the RCS server 300 of FIG. 3) or may control the communication circuit 530 to receive data from the RCS server 300. The processor 520 may transmit a message to the first electronic device 400 or receive a message transmitted by the first electronic device 400 in response to completing of the registration procedure with the RCS server 300.

An RCS application (not shown) may be executed on the processor 520. The RCS application may be an application that processes messages exchanged between the RCS server 300 and the second electronic device 500 and performs a function of displaying or outputting processed data. The RCS application may provide a user interface capable of providing first messages to a user. For example, the RCS application may provide an interface that provides a user with a message received from the RCS server 300 and/or a message received from the first electronic device 400 through the RCS server 300, and may provide an interface through which a message, which is transmitted to the first electronic device 400 through the RCS server 300, is input.

The processor 520 may receive a second message from the first electronic device 400 through the RCS server 300. The second message may include identification information of a specific function, identification information of an first message related to a specific function, at least a part of the first message, and/or input data. The specific function related to a message exchanged with the first electronic device 400 may include various functions such as: a function of replying to messages that have been previously exchanged between the first electronic device 400 and the second electronic device 500; a function of deleting, on the second electronic device 500, at least one message among messages that have been previously exchanged between the first electronic device 400 and the second electronic device 500; a function of adding data (e.g., emoticons) relating to messages that have been previously exchanged between the first electronic device 400 and the second electronic device 500; and/or a function of deleting data (e.g., emoticons) relating to messages that have been previously exchanged between the first electronic device 400 and the second electronic device 500.

The processor 520 may receive the second message and parse the received second message. The processor 520 may extract identification information of a specific function, identification information of an first message related to a specific function, at least part of the first message, and/or input data through parsing of the second message. A delimiter may exist between at least a part of the first message and the input data. The delimiter may be predetermined between the first electronic device 400 and the second electronic device 500.

The processor 520 may identify whether the second electronic device 500 supports a specific function based on identification information of the specific function. The processor 520 may identify whether the second electronic device 500 supports a specific function, based on data, in which a specific function related to the RCS message service, supported by the second electronic device 500, is stored, and identification information of the specific function, which is stored in the second message.

In response to identifying that the second electronic device 500 supports a specific function, the processor 520 may identify the first message stored in the memory 510 based on identification information of the first message included in the second message. The processor 520 may process the second message in a manner of displaying the identified first message and data included in the second message together. The processor 520 may distinguish data included in the second message and at least a part of the first message based on a delimiter included in the second message, and may display the first message stored in the memory 510 with the distinguished data together.

The processor 520 may identify, in the second message, identification information of the specific function corresponding to the reply function. The processor 520 may identify the identification information of the first message included in the second message, and may display the first message and the data in the second message together such that the data in the second message is displayed in the form of a reply to the first message.

When a specific function is a function of transmitting a designated emoticon of the first message, the processor 520 may identify, in the second message, identification information of the specific function corresponding to the emoticon transmission function. The processor 520 may identify information indicating an emoticon from data in the second message, and may display the identified emoticon together with the first message.

When a specific function is a function of sharing the first message, the processor 520 may identify, in the second message, identification information of the specific function corresponding to the sharing function. The processor 520 may identify an address, at which the first message can be received, from data in the second message, and may receive the first message based on the address. The processor 520 may display the received first message.

In response to identifying that the second electronic device 500 does not support a specific function, the processor 520 may process the second message in a manner of displaying at least a part of the first message and data included in the second message. The processor 520 may display together at least a part of the first message, a delimiter, and/or data, which are included in the second message.

When a specific function is a function of replying to the first message, the processor 520 may identify, in the second message, identification information of the specific function corresponding to the reply function. In response to identifying that the second electronic device 500 does not support the identified function, the processor 520 may display together at least a part of the first message and data included in the second message.

When a specific function is a function of transmitting a designated emoticon of the first message, the processor 520 may identify, in the second message, identification information of the specific function corresponding to the emoticon transmission function. In response to identifying that the second electronic device 500 does not support the identified function, the processor 520 may display together at least part of the first message and data (e.g., information indicating that the user of the first electronic device 400 has added an emoticon to the first message) included in the second message.

According to an embodiment, when a specific function is a function of sharing the first message, the processor 520 may identify, in the second message, identification information of the specific function corresponding to the sharing function. In response to identifying that the second electronic device 500 does not support the identified function, the processor 520 may display together at least a part of the first message included in the second message (e.g., a part of the first message to be shared) and data included in the second message.

Through the method described above, the second electronic device 500 may receive a second message that can be processed by the second electronic device 500 regardless of whether the second electronic device 500 supports a specific function. Therefore, when the second electronic device 500 that does not support a specific function receives the second message, the second electronic device 500 may display (or output) the first message related to the specific function and data input by a user of the first electronic device 400, in a similar manner of supporting the specific function.

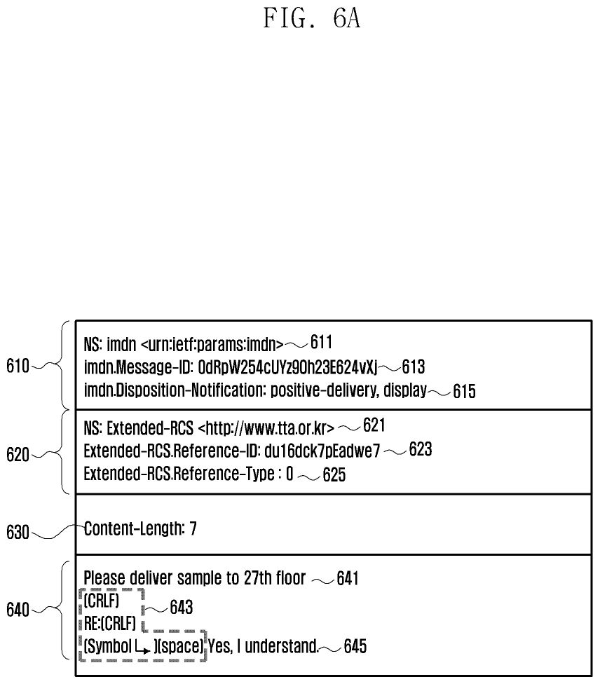

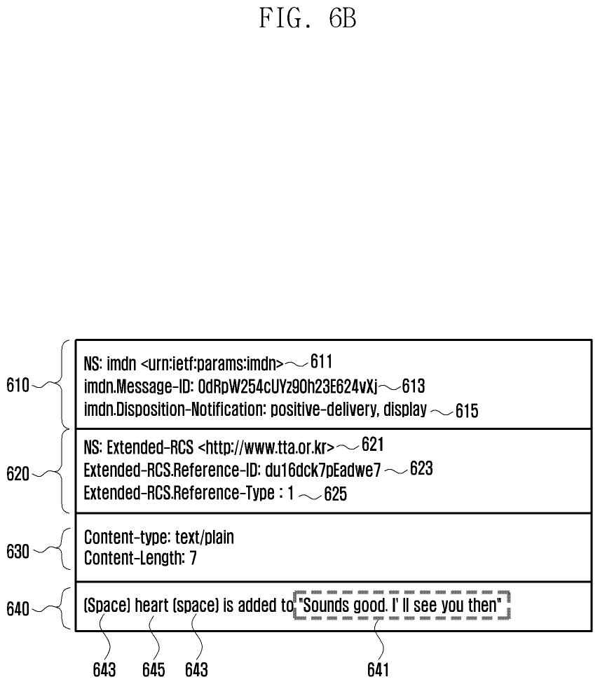

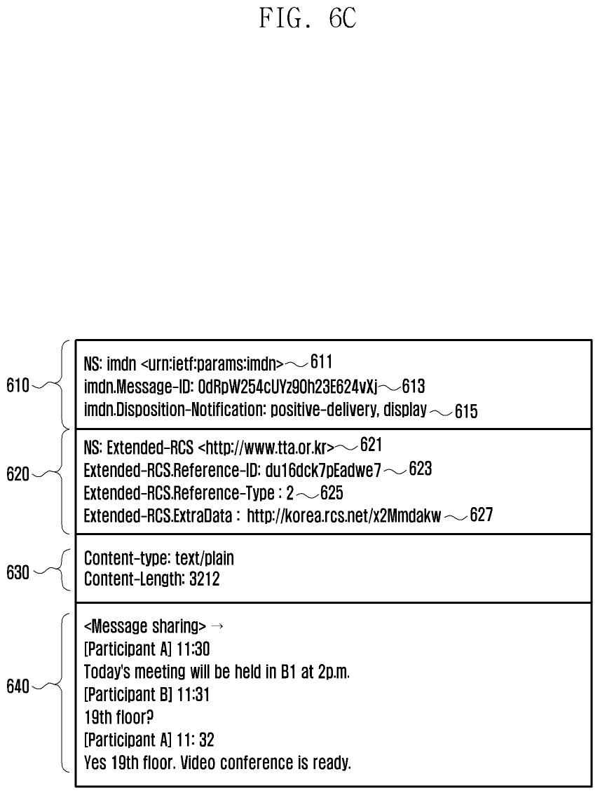

FIG. 6A illustrates a format of messages exchanged between a first electronic device and a second electronic device according to certain embodiments, FIG. 6B illustrates a format of messages exchanged between a first electronic device and a second electronic device according to certain embodiments, and FIG. 6C illustrates a format of messages exchanged between a first electronic device and a second electronic device according to certain embodiments.

FIG. 6A illustrates a format of a second message implemented when using a reply function.

The second message includes an identification of the replied to first message 620, at least a part of the first message 641, and message data 645. When the second electronic device 500 supports the reply function, the second electronic device 500 uses the identified of the replied to first message 620 to fetch it from memory and display it, and the data 645 from the second message. When the second electronic device 500 does not support the reply function, the second electronic device 500 displays the at least a part of the first message 641, and the message data 645.

Since the second message includes at least the part of the replied to first message 641, even if the second electronic device 500 does not support the reply function, the second electronic device 500 can process the second message 500.

The second message may include identification information of a specific function, identification information of an first message related to a specific function, at least part of the first message, and/or input data.

A header 610 of the second message may include message information which a receiving electronic device (e.g., the second electronic device 500) processes regardless of whether the it supports a specific function. The header 610 may include identification information 613 of the second message, notification information 615 requested, when the second message is received, by the first electronic device 400 that transmits the second message, and a part 611 defining a variable of the identification information 613 and the notification information 615.

The second message may include a specific functional area 620 that can be parsed when an electronic device (e.g., the second electronic device 500) receiving the second message supports a specific function. The specific functional area 620 may include identification information 623 of a first message related to a specific function (e.g., du16dck7pEadwe7, which is identification information of the first message for which a reply is to be provided), identification information 625 of a specific function (e.g., 0, which is identification information indicating that a specific function is the reply function), and a field 621 defining a variable of the identification information 623 of the first message and identification information 625 of the specific function.

The second message may include a body 640 including at least a part of the first message and input data. The second message may further include a length indication area 630 indicating the length of the body 640.

The body 640 of the second message may include at least a part 641 of the first message (e.g., “please deliver a sample to the 27th floor”), input data 645 (e.g., “yes, I understand”), and/or a delimiter 643 (e.g., (CRLF) RE: (CRLF)→(space)) for distinguishing at least a part 641 of the first message and the data 645.

The second electronic device 500 having received the second message defined in FIG. 6A may identify a specific functional area 620 through parsing of the second message, and may identify identification information of a specific function included in the specific function area 620. The second electronic device 500 may identify whether a specific function is supported, based on identification information of the specific function.

The second electronic device 500 supporting a specific function may identify the first message stored in the memory 510 based on the identification information 623 in the second message. The second electronic device 500 may process the second message in a manner of displaying together the identified first message and the data 645 included in the second message. The second electronic device 500 may distinguish the data 645 included in the second message and at least a part 641 of the first message based on the delimiter 643. The second electronic device 500 may display together the first message stored in the memory 510 and the distinguished data 645.

The second electronic device 500 that does not support a specific function may process the second message in a manner of displaying together at least a part 641 of the first message included in the second message and the data 645. The second electronic device 500 may display together at least a part 641 of the first message, the delimiter 643, and/or the data 645 included in the second message.

FIG. 6B illustrates a second message format implemented when a specific function related to messages exchanged between the first electronic device 400 and the second electronic device 500 is an emoticon transmission function. The second message includes identification information 613 of the replied to first message, at least a part 641 of the replied to first message, and data 645. The data 645 from the message is separated from the at least the part 641 of the replied to first message by delimiters 643. The data 645 is the heart emoticon, “heart”. When the second electronic device 500 supports emoticons, the second electronic device uses the identification information 613 to fetch and display the replied to message, and from the data 645 (“heart”) displays an emoticon for a heart annotating the message. When the second device 500 does not support emoticons, the second electronic device 500 displays the heart emoticon and writes “is added to ‘Sounds good. I'll see you then.’”

The second message may include identification information of a specific function, identification information of a first message related to a specific function, at least part of the first message, and/or input data.

A header 610 of the second message may include message information which an electronic device (e.g., the second electronic device 500) receiving a second message processes regardless of whether the electronic device supports a specific function. The header 610 may include identification information 613 of the second message, notification information 615 requested, when the second message is received, by the first electronic device 400 that transmits the second message, and a part 611 defining a variable of the identification information 613 and the notification information 615.

The second message may include a specific functional area 620 that can be parsed when an electronic device (e.g., the second electronic device 500) receiving the second message supports a specific function (e.g., an emoticon transmission function). The specific functional area 620 may include identification information 623 of a first message related to a specific function (e.g., du16dck7pEadwe7, which is identification information of the first message for which a reply is to be provided), identification information 625 of a specific function (e.g., 1, which is identification information indicating that a specific function is the emoticon transmission function), and a part 621 defining a variable of the identification information 623 of the first message and identification information 625 of the specific function.

The second message may include a body 640 including at least a part of the first message and input data. The second message may further include a type (e.g., text) of contents included in the body 640 and a length indication area 630 indicating the length of the body 640.

The body 640 of the second message may include at least a part 641 of the first message (e.g., “Sounds good. I'll see you then”), input data 645 (e.g., heart), and/or a delimiter 643 (e.g., (space) (space)) for distinguishing at least a part 641 of the first message and the data 645.

The second electronic device 500 having received the second message defined in FIG. 6B may identify a specific functional area 620 through parsing of the second message, and may identify identification information of a specific function included in the specific function area 620. The second electronic device 500 may identify whether a specific function is supported, based on identification information of the specific function.

The second electronic device 500 supporting a specific function may identify the first message stored in the memory 510, based on the identification information 623 of the first message included in the second message. The second electronic device 500 may process the second message in a manner of displaying together the identified first message and the data 645 included in the second message. The second electronic device 500 may distinguish the data 645 included in the second message and at least a part 641 of the first message based on the delimiter 643 included in the second message, and may display the first message stored in the memory 510 and the distinguished data 645 together. The second electronic device 500 may display the identified second message, annotated with the heart emoticon.

The second electronic device 500 that does not support a specific function may process the second message in a manner of displaying together at least a part 641 of the first message included in the second message and the data 645. The second electronic device 500 may display together at least a part 641 of the first message, a delimiter 643, and/or data 645 included in the second message. The second electronic device 500 may display the heart emoticon, followed by “is added to ‘Sounds good. I'll see you then.’”

FIG. 6C illustrates a second message format implemented when a specific function related to messages exchanged between the first electronic device 400 and the second electronic device 500 is a function of sharing the first message.

According to certain embodiments, the second message may include identification information of a specific function, identification information of a first message related to a specific function, at least part of the first message, and/or input data.

A header 610 of the second message may be an area including message information which an electronic device (e.g., the second electronic device 500) receiving a second message processes regardless of whether the electronic device supports a specific function. The header 610 may include identification information 613 of the second message, notification information 615 requested, when the second message is received, by the first electronic device 400 that transmits the second message, and a part 611 defining a variable of the identification information 613 and the notification information 615.

The second message may include a specific functional area 620 that can be parsed when an electronic device (e.g., the second electronic device 500) receiving the second message supports a specific function (e.g., a function of sharing the first message). The specific functional area 620 may include identification information 623 of a first message related to a specific function (e.g., du16dck7pEadwe7, which is identification information of the first message for which a reply is to be provided), identification information 625 of a specific function (e.g., 2, which is identification information indicating that the specific function is a function of sharing the first message), an address 627 at which the first message is uploaded (e.g., http://korea.rcs.net/x2Mmdakw), and a part 621 defining a variable of the identification information 625 of the specific function.

The second message may include a body 640 including at least a part of the first message and input data. The second message may further include a type (e.g., text) of contents included in the body 640 and a length indication area 630 indicating the length of the body 640.

The body 640 of the second message may include at least a part of the first message to be shared (e.g., “<message sharing>→[participant A] . . . Video conference is ready”).

According to certain embodiments, the second electronic device 500 having received the second message defined in FIG. 6C may identify a specific functional area 620 through parsing of the second message, and may identify identification information of a specific function included in the specific function area 620. The second electronic device 500 may identify whether a specific function is supported, based on identification information of the specific function.

The second electronic device 500 supporting a specific function may identify the address 627 at which the first message included in the specific functional area 620 is uploaded, and may access the address, at which the first message is uploaded, to receive the first message. The second electronic device 500 may process the second message in a manner of displaying the received first message together.

The second electronic device 500 that does not support a specific function may process the second message in a manner of displaying at least a part 640 of the first message included in the second message.

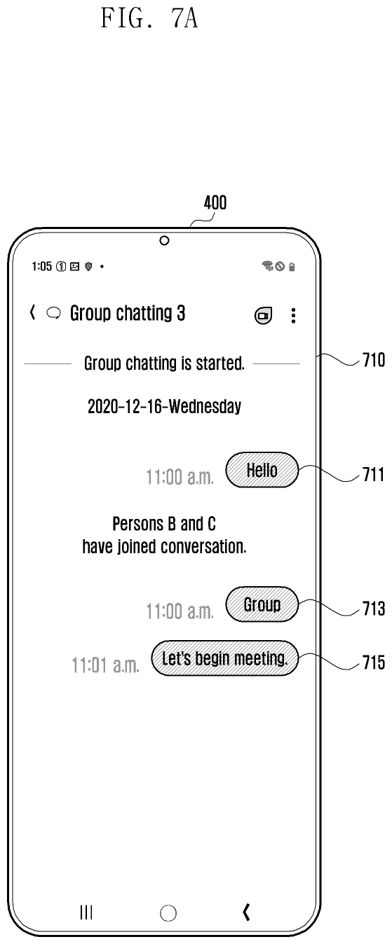

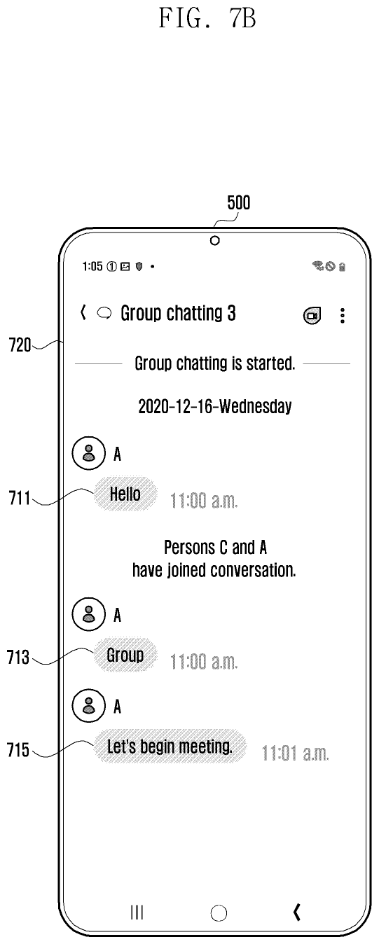

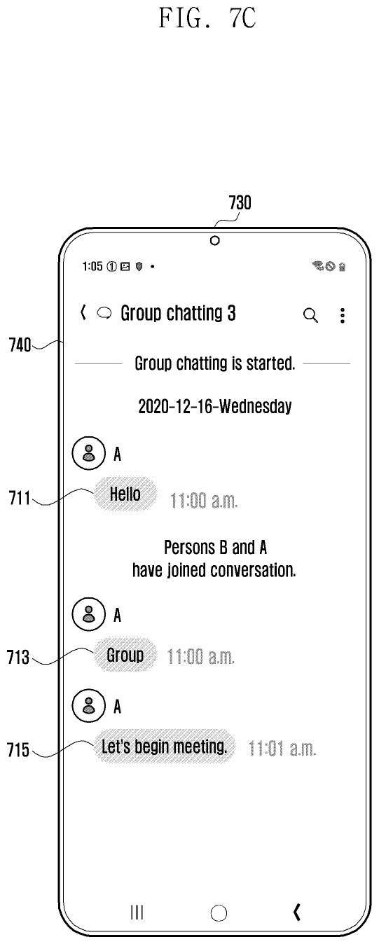

FIG. 7A illustrates an embodiment in which messages exchanged among a first electronic device, a second electronic device, and a third electronic device are displayed according to certain embodiments, FIG. 7B illustrates an embodiment in which messages exchanged among a first electronic device, a second electronic device, and a third electronic device are displayed according to certain embodiments, and FIG. 7C illustrates an embodiment in which messages exchanged among a first electronic device, a second electronic device, and a third electronic device are displayed according to certain embodiments.

According to certain embodiments, a first electronic device (e.g., the first electronic device 400 of FIG. 3), a second electronic device (e.g., the second electronic device 500 of FIG. 3), and/or a third electronic device 730 (e.g., the electronic device 104 of FIG. 1) may exchange messages through an RCS server (e.g., the RCS server 300 of FIG. 3).

FIG. 7A illustrates an embodiment in which messages are displayed on a display 710 (e.g., the display module 160 of FIG. 1) of the first electronic device 400.

According to certain embodiments, the first electronic device 400 may transmit input messages 711, 713, and 715 to the second electronic device 500 and/or the third electronic device 730 through the RCS server 300 according to a user input on the display 710.

FIG. 7B illustrates an embodiment in which messages are displayed on a display 720 (e.g., the display module 160 of FIG. 1) of the second electronic device 500.

According to certain embodiments, the second electronic device 400 may receive messages 711, 713, and 715, transmitted by the first electronic device 400, through the RCS server 300, and may display the received messages on the display 720.

FIG. 7C illustrates an embodiment in which messages are displayed on a display 740 (e.g., the display module 160 of FIG. 1) of the third electronic device 730.

According to certain embodiments, the third electronic device 730 may receive the messages 711, 713, and 715, transmitted by the first electronic device 400, through the RCS server 300, and may display the received messages on the display 740.

Hereinafter, for the convenience of explanation, the first electronic device 400 and the second electronic device 500 are assumed to be electronic devices that support a specific function, and the third electronic device 730 is assumed to be an electronic device that does not support a specific function.

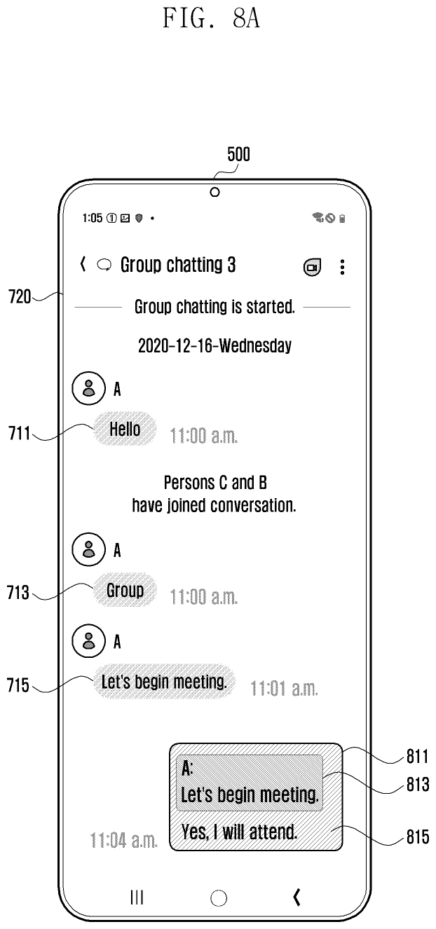

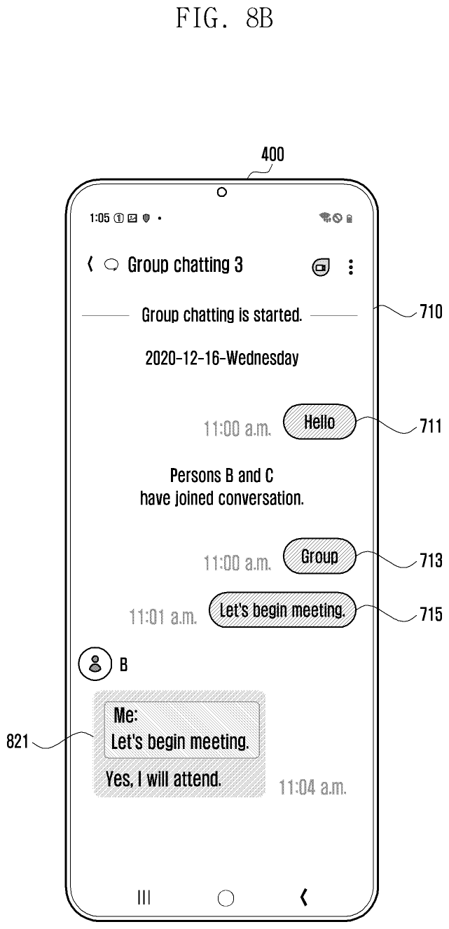

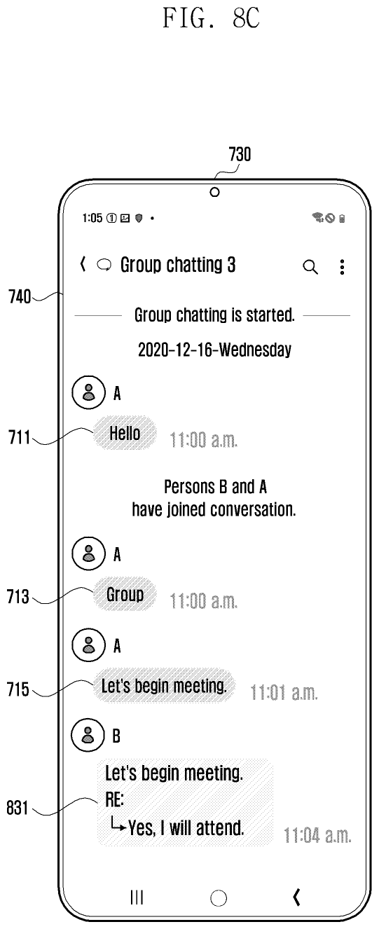

FIG. 8A illustrates an embodiment in which messages exchanged among a first electronic device, a second electronic device, and a third electronic device are displayed according to certain embodiments, FIG. 8B illustrates an embodiment in which messages exchanged among a first electronic device, a second electronic device, and a third electronic device are displayed according to certain embodiments, and FIG. 8C illustrates an embodiment in which messages exchanged among a first electronic device, a second electronic device, and a third electronic device are displayed according to certain embodiments.

FIG. 8A illustrates an embodiment in which messages are displayed on a display (e.g., the display 720 of FIG. 7B) of the second electronic device 500.

According to certain embodiments, the second electronic device 500 may receive, on the display 720, a user input for activating a specific function. According to an embodiment, when a specific function is a function of replying to a specific message 715, the second electronic device 500 may receive a user input for selecting the specific message 715 and/or activating a function of replying to the specific message 715. In response to receiving the user input for activating the specific function, the second electronic device 500 may control the display 720 to display a user interface (e.g., a virtual keypad) for additional user input (e.g., input of a reply message). The second electronic device 500 may transmit a second message to the first electronic device 400 and/or the third electronic device 730 in response to receiving the additional user input.

The second message may include identification information of a specific function, identification information of the first message 715 related to the specific function, at least a part of the first message 715, and/or input data 815.

In response to transmission of the second message, the second electronic device 500 may display a second message 811 including an area 813 in which contents of the first message 715 are included and an area 815 in which additional user input is included.

FIG. 8B illustrates an embodiment in which messages are displayed on a display (e.g., the display 710 of FIG. 7A) of the first electronic device 400.

Referring to FIG. 8B, in response to receiving the second message 811, the first electronic device 400 supporting a specific function may identify the first message 715 stored in a memory (the memory 410 of FIG. 4), based on identification information of the first message 715 included in the second message. The first electronic device 400 may process the second message 811 in a manner of displaying together the identified first message 715 and data included in the second message 811. The first electronic device 400 may display a message 821 including contents of the first message 715 stored in the memory 410 and data of the second message 811.

FIG. 8C illustrates an embodiment in which messages are displayed on a display (e.g., the display 740 of FIG. 7C) of the third electronic device 730.

Referring to FIG. 8C, in response to receiving the second message 811, the third electronic device 730 that does not support a specific function may process the second message 811 in a manner of displaying together at least a part (e.g., Let's begin the meeting) of the first message 715 and data (e.g., Yes, I will attend) included in the second message 811, and may display the received second message 811.

The third electronic device 730 may display the second message 831 such that at least a part of the first message 715 included in the second message 811, data included in the second message 811, and/or a delimiter (e.g., the delimiter 643 of FIG. 6A) included in the second message 811 are included.

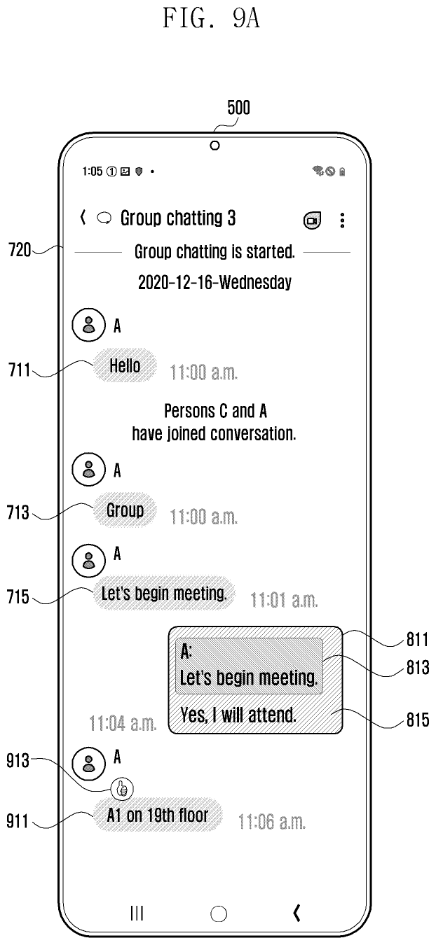

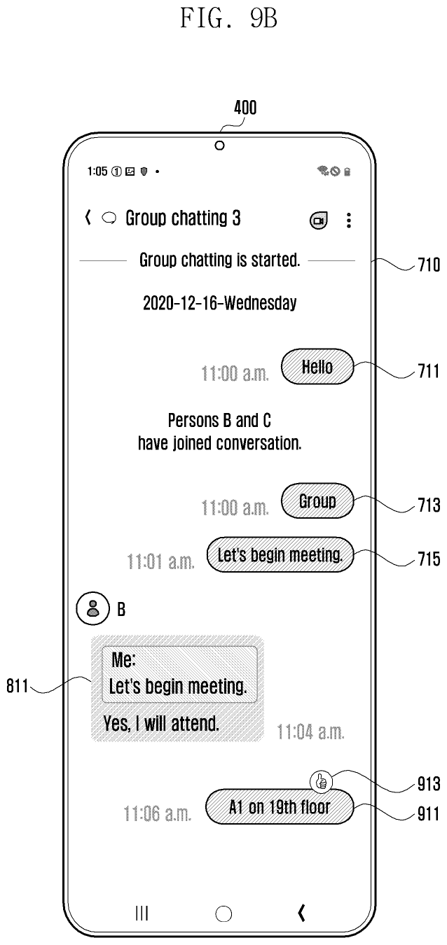

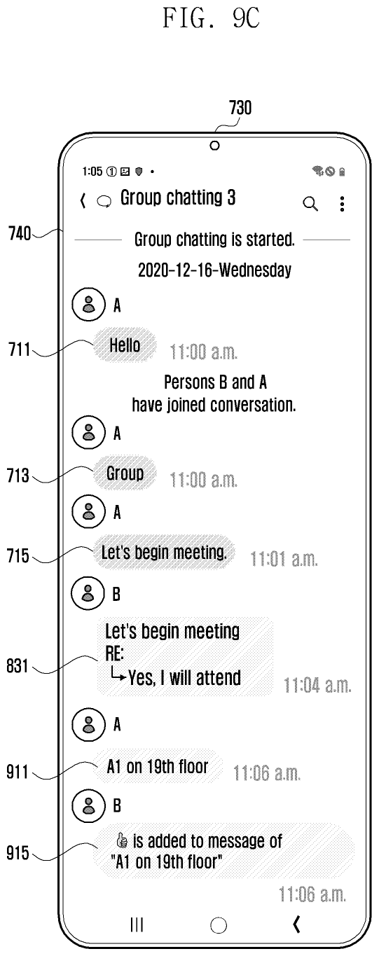

FIG. 9A illustrates an embodiment in which messages exchanged among a first electronic device, a second electronic device, and a third electronic device are displayed according to certain embodiments, FIG. 9B illustrates an embodiment in which messages exchanged among a first electronic device, a second electronic device, and a third electronic device are displayed according to certain embodiments, and FIG. 9C illustrates an embodiment in which messages exchanged among a first electronic device, a second electronic device, and a third electronic device are displayed according to certain embodiments.

FIG. 9A illustrates an embodiment in which messages are displayed on a display (e.g., the display 720 of FIG. 7B) of the second electronic device 500.

According to certain embodiments, the second electronic device 500 may receive, on the display 720, a user input for activating a specific function. According to an embodiment, when a specific function is a function of transmitting an emoticon for a specific message 911, the second electronic device 500 may receive a user input for selecting the specific message 911 and/or activating a function of transmitting an emoticon for the specific message 911. In response to receiving the user input for activating the specific function, the second electronic device 500 may control the display 720 to display a user interface (e.g., an emoticon list) for additional user input (e.g., selection of an emoticon). The second electronic device 500 may transmit a second message including information indicating the selected emoticon to the first electronic device 400 and/or the third electronic device 730 according to reception of the additional user input.

The second message may include identification information of a specific function, identification information of the first message 911 related to the specific function, at least a part of the first message 911, and/or input data 913.

In response to transmission of the second message, the second electronic device 500 may display together the first message 911 and a second message including an emoticon 913 relating to the first message 911.

FIG. 9B illustrates an embodiment in which messages are displayed on a display (e.g., the display 710 of FIG. 7A) of the first electronic device 400.

Referring to FIG. 9B, in response to receiving the second message, the first electronic device 400 supporting a specific function (e.g., a function of receiving an emoticon) may identify the first message 911 stored in a memory (the memory 410 of FIG. 4), based on identification information of the first message 911 included in the second message. The first electronic device 400 may process the second message in a manner of displaying together the identified first message 911 and data (e.g., information indicating an emoticon) included in the second message. The first electronic device 400 may display contents of the first message 911 stored in the memory 410 and the emoticon 913 corresponding to information indicating an emoticon.

FIG. 9C illustrates an embodiment in which messages are displayed on a display (e.g., the display 740 of FIG. 7C) of the third electronic device 730.

Referring to FIG. 9C, in response to receiving the second message, the third electronic device 730 that does not support a specific function (e.g., a function of receiving an emoticon) may process the second message in a manner of displaying together at least a part (e.g., A1 on the 19th floor) of the first message 911 and data (e.g., an emoticon is added to the message) included in the second message 915, and may display the received second message 915.

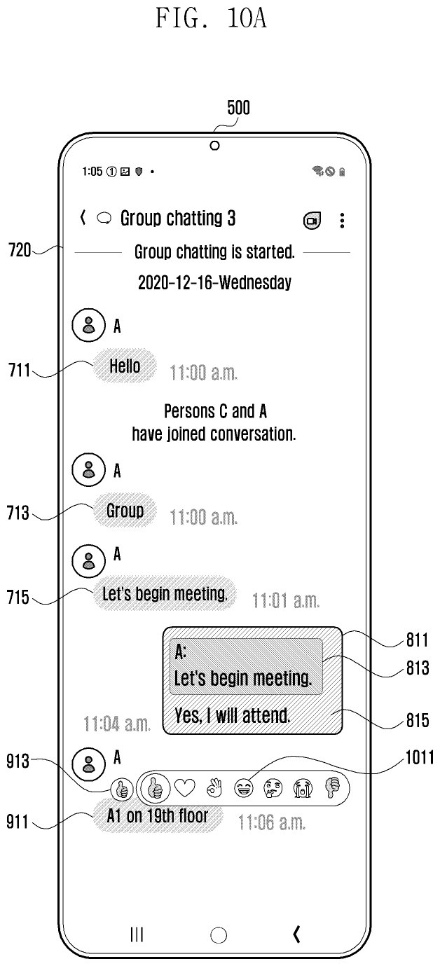

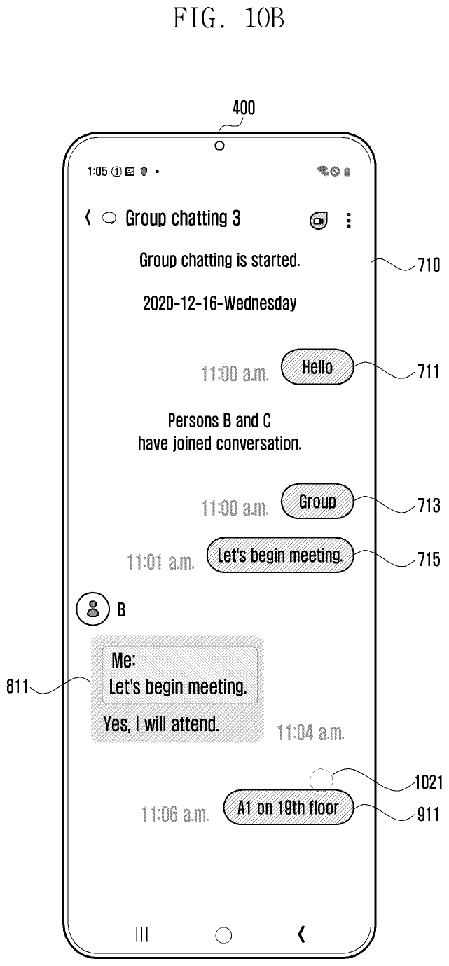

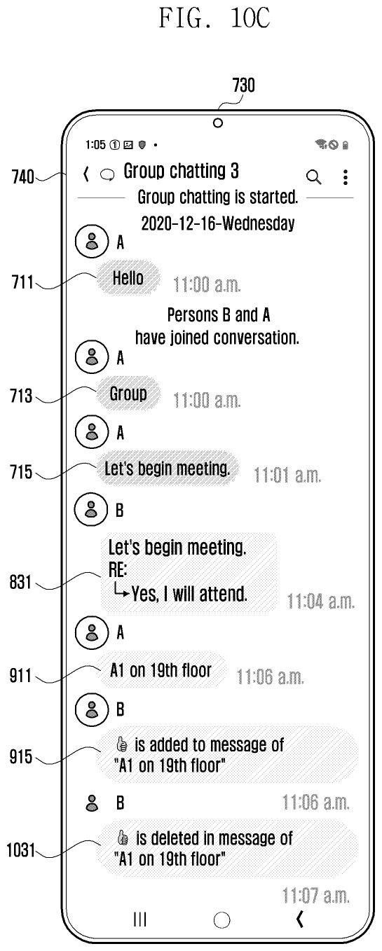

FIG. 10A illustrates an embodiment in which messages exchanged among a first electronic device, a second electronic device, and a third electronic device are displayed according to certain embodiments, FIG. 10B illustrates an embodiment in which messages exchanged among a first electronic device, a second electronic device, and a third electronic device are displayed according to certain embodiments, and FIG. 10C illustrates an embodiment in which messages exchanged among a first electronic device, a second electronic device, and a third electronic device are displayed according to certain embodiments.

FIG. 10A illustrates an embodiment in which messages are displayed on a display (e.g., the display 720 of FIG. 7B) of the second electronic device 500.

According to certain embodiments, the second electronic device 500 may receive, on the display 720, a user input for activating a specific function. According to an embodiment, when the specific function is a function of canceling transmission of an emoticon for a specific message 911, the second electronic device 500 may receive a user input for selecting an emoticon 913 displayed together with the specific message 911 and/or activating a function of canceling transmission of the emoticon 913 for the specific message 911. In response to receiving a user input for activating the specific function, the second electronic device 500 may control the display 720 to display a user interface (e.g., an emoticon list 1011) for additional user input (e.g., selection of the emoticon 913). The second electronic device 500 may transmit a second message including information indicating an emoticon 913, of which transmission is to be cancelled, to the first electronic device 400 and/or the third electronic device 730 according to reception of an additional user input.

The second message may include identification information of a specific function, identification information of the first message 911 related to the specific function, at least a part of the first message 911, and/or input data 913.

The second electronic device 500 may display the first message 911 from which the emoticon 913 is deleted in response to transmission of the second message.

FIG. 10B illustrates an embodiment in which messages are displayed on a display (e.g., the display 710 of FIG. 7A) of the first electronic device 400.

Referring to FIG. 10B, in response to receiving a second message, the first electronic device 400 supporting a specific function (e.g., a function of canceling emoticon transmission) may identify the first message 911 stored in a memory (the memory 410 of FIG. 4), based on identification information of the first message 911 included in the second message. The first electronic device 400 may process the second message in a manner of displaying together the identified first message 911 and data (e.g., information indicating an emoticon 913, of which transmission is to be cancelled) included in the second message. The first electronic device 400 may switch from a state of displaying contents of the first message 911 stored in the memory 410 and the emoticon 913 corresponding to information indicating an emoticon to a state of displaying the contents of the first message 911.

FIG. 10C illustrates an embodiment in which messages are displayed on a display (e.g., the display 740 of FIG. 7C) of the third electronic device 730.

Referring to FIG. 10C, in response to receiving of the second message 1031, the third electronic device 730 that does not support a specific function (e.g., a function of canceling transmission of an emoticon) may process the second message in a manner of displaying together at least a part (e.g., Al on the 19th floor) of the first message 911 and data (e.g., the emoticon included in the message has been deleted) included in the second message 915, and may display the received second message 1031.

An electronic device according to certain embodiments may include: a memory configured to store a first message exchanged with an external electronic device; a wireless communication circuit; and a processor, wherein the processor is configured to: perform a registration procedure with a rich communication service (RCS) server; receive a user input for activating a specific function related to a message exchanged with the external electronic device; generate a second message including identification information of the specific function, identification information of a first message related to the specific function, at least a part of the first message, and/or input data; and transmit the second message to the external electronic device through the RCS server.

In an electronic device according to certain embodiments, the processor may be configured to generate the second message regardless of whether the external electronic device supports the specific function.

In an electronic device according to certain embodiments, the first message may be stored in both the electronic device and the external electronic device.

In an electronic device according to certain embodiments, the processor may be configured to: identify the size of the first message; and in response to the size of the first message being equal to or larger than the designated size, add at least a part extracted from the first message to the second message.

In an electronic device according to certain embodiments, the specific function may include a function of replying to the first message, and the processor may be configured to transmit a second message including at least a part of the first message and data corresponding to a user input relating to the first message.

In an electronic device according to certain embodiments, the specific function may include a function of displaying a designated emoticon of the first message, and the processor may be configured to transmit the second message including at least a part of the first message and information indicating the emoticon.

In an electronic device according to certain embodiments, the specific function may include a function of sharing a message stored in the electronic device, and the processor may be configured to: upload the stored message to an external server; and transmit the second message including an address on the external server, which corresponds to the uploaded message.

An electronic device according to certain embodiments may include: a memory configured to store at least one first message exchanged with an external electronic device; a wireless communication circuit; and a processor, wherein the processor is configured to: perform a registration procedure with a rich communication service (RCS) server; receive a second message including identification information of a specific function, identification information of a first message related to the specific function, at least part of the first message and/or data; in response to identifying that the electronic device supports a specific function based on the identification information of the specific function, identify the first message stored in the memory based on the identification information of the first message; and process the second message to display the identified first message and the data together.

In an electronic device according to certain embodiments, the processor may be configured to process the second message to display at least a part of the first message and the data together, in response to identifying that the electronic device does not support the specific function based on the identification information of the specific function.

In an electronic device according to certain embodiments, the processor may be configured to: identify a delimiter between at least a part of the first message and/or the data through parsing of the second message; in response to identifying that the electronic device supports the specific function based on the identification information of the specific function, extract the data based on the delimiter; and process the second message to display together the first message stored in the memory and the extracted data.

In an electronic device according to certain embodiments, the processor may be configured to process the second message to display together at least a part of the first message, the delimiter, and/or the data, which are included in the second message, in response to identifying that the electronic device does not support the specific function based on the identification information of the specific function.

In an electronic device according to certain embodiments, the specific function may include a function of displaying a designated emoticon of the first message, and the processor may be configured to: display an emoticon corresponding to the extracted data together with the first message stored in the memory, or terminate displaying of the emoticon according to reception of a second message indicating a function of canceling the displaying of the emoticon.

In an electronic device according to certain embodiments, the specific function may include a function of sharing a message stored in the external electronic device, and the processor may be configured to: receive the second message including an address on an external server, which corresponds to the message to be shared; receive the message to be shared, based on the address on the external server; and display the message to be shared.

In an electronic device according to certain embodiments, the first message may be stored in both the electronic device and the external electronic device.

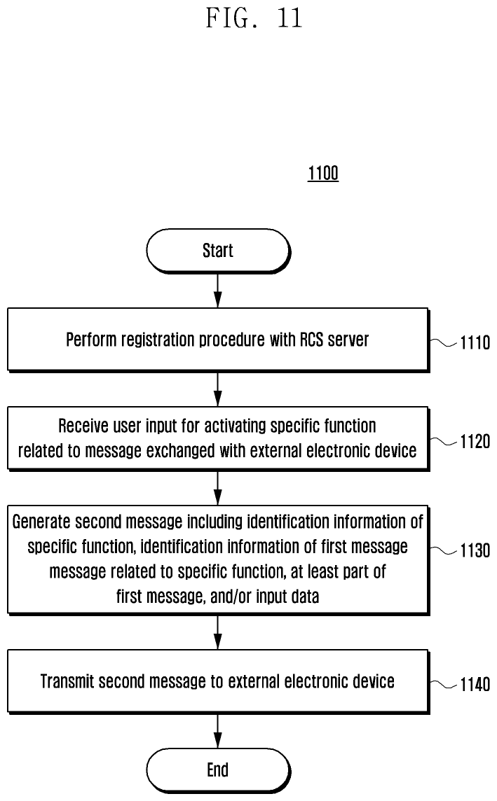

FIG. 11 is a flowchart illustrating an operation method of an electronic device according to certain embodiments.

According to certain embodiments, an electronic device (e.g., the first electronic device 400 of FIG. 3) may perform a registration procedure with an RCS server (e.g., the RCS server 300 of FIG. 3) in operation 1110.

According to certain embodiments, the procedure of registering the electronic device 400 on the RCS server 300 may include an operation of registering an address of the electronic device 400 on the RCS server 300, the address being that which the electronic device 400 uses for data transmission to or data reception from the RCS server 300. The address of the electronic device 400 may denote an IP address of the electronic device 400 on a network to which the electronic device 400 is connected.

According to certain embodiments, in operation 1120, the electronic device 400 may receive a user input for activating a specific function related to a first message exchanged with an external electronic device (e.g., the second electronic device 500 of FIG. 3).

According to certain embodiments, specific functions related to messages exchanged with an external electronic device 500 may include various functions such as: a function of replying to messages that have been previously exchanged between the electronic device 400 and the external electronic device 500; a function of deleting, on the external electronic device 500, at least one message among messages that have been previously exchanged between the electronic device 400 and the external electronic device 500; a function of adding data (e.g., emoticons) relating to messages that have been previously exchanged between the electronic device 400 and the external electronic device 500; and/or a function of deleting data (e.g., emoticons) relating to messages that have been previously exchanged between the electronic device 400 and the external electronic device 500.

According to certain embodiments, in operation 1130, the electronic device 400 may generate a second message including identification information of a specific function, identification information of a first message related to the specific function, at least a part of the first message, and/or input data.

According to certain embodiments, the electronic device 400 may identify identification information of the specific function corresponding to a user input for activating the specific function. For example, when the specific function is a function of replying to a first message, the electronic device 400 may identify identification information corresponding to the reply function and add the identified identification information to the second message. For another example, if the specific function is a function of transmitting a designated emoticon of the first message, the electronic device 400 may identify the identification information corresponding to the emoticon transmission function, and may add the identified identification information to the second message. For another example, when the specific function is a function of sharing the first message stored in the memory 410, the electronic device 400 may identify identification information corresponding to the sharing function, and may add the identified identification information to the second message.

According to certain embodiments, the electronic device 400 may receive, through a user interface, data (e.g., text, an image, and/or video) to be transmitted to the external electronic device 500 and a user input for activating a specific function, and may generate a second message such that input data is included therein. When the specific function is a function of replying to a first message, the electronic device 400 may add data input through the user interface to the second message. For another example, when the specific function is a function of transmitting a designated emoticon of the first message, the electronic device 400 may add information indicating an emoticon selected through a user input to the second message. For another example, when a specific function is a function of sharing a first message, the electronic device 400 may upload a first message to be shared to an external server, may identify an address of the external server (not shown) in which the first message to be shared is stored, and may add the address to the second message.

According to certain embodiments, in response to a user input for activating a specific function, the electronic device 400 may identify identification information of a first message related to a specific function. The electronic device 400 and/or the external electronic device 500 may store a first message exchanged with each other, and identification information of the first message stored in the electronic device 400 may be the same as identification information of the first message stored in the external electronic device 500. The external electronic device 500 may perform a specific function based on identification information of the first message. When the specific function is a function of replying to the first message, the electronic device 400 may identify the first message for which a reply is to be provided, and may add identification information of the identified first message to the second message. For another example, when the specific function is a function of transmitting a designated emoticon of the first message, the electronic device 400 may identify the first message, to which the emoticon is to be transmitted, and may add identification information of the identified first message to the second message.

According to certain embodiments, the electronic device 400 may generate a second message such that at least a part of the first message related to a specific function is included in the second message. The electronic device 400 may allow at least a part of the first message to be included in the second message at the time of generation thereof, and thus may allow a user of the external electronic device 500 to identify a message related to the specific function even when the electronic device (e.g., the second electronic device 500) having received the second message does not support the specific function.

According to certain embodiments, in operation 1140, the electronic device 400 may transmit the second message to the external electronic device 500.

According to certain embodiments, regardless of whether the external electronic device 500 supports a specific function, the electronic device 400 may generate a second message including data for execution of a specific function and data (e.g., contents desired to be transmitted by a user) input through a user interface, and may transmit the second message to the second electronic device 500. When the external electronic device 500 having received the second message supports a specific function, the external electronic device 500 may identify the data for execution of the specific function, and may process the second message based on the identified data. When the external electronic device 500 does not support a specific function, the external electronic device 500 may output data, which is included in the second message and input through the user interface.

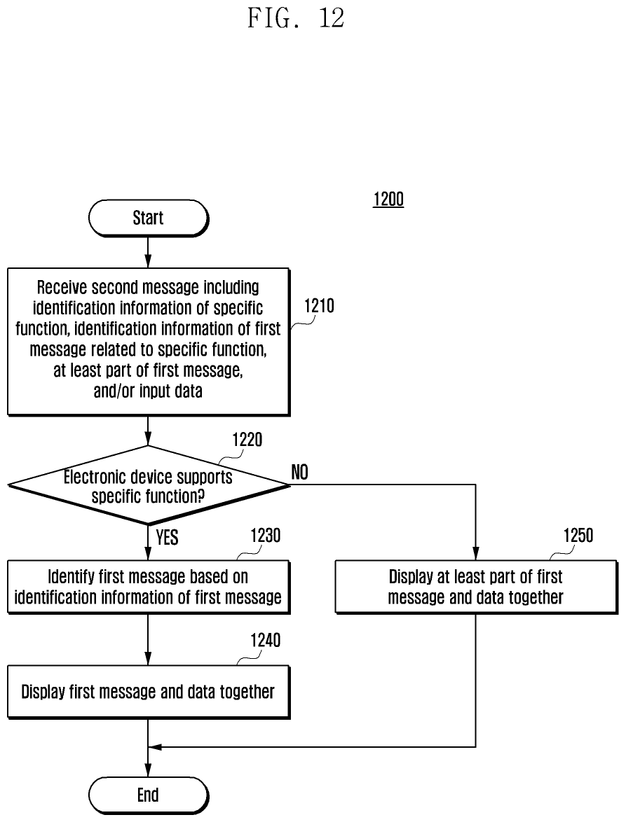

FIG. 12 is a flowchart illustrating an operation method of an electronic device according to certain embodiments.

According to certain embodiments, in operation 1210, an electronic device (e.g., the second electronic device 500 of FIG. 3) may receive, from an external electronic device (e.g., the first electronic device 400 of FIG. 3), a second message including identification information of a specific function, identification information of a first message related to a specific function, at least part of the first message, and/or input data.

According to certain embodiments, specific functions related to messages exchanged with an external electronic device 400 may include various functions such as: a function of replying to messages that have been previously exchanged between the electronic device 500 and the external electronic device 400; a function of deleting, on the electronic device 500, at least one message among messages that have been previously exchanged between the electronic device 500 and the external electronic device 400; a function of adding data (e.g., emoticons) relating to messages that have been previously exchanged between the electronic device 500 and the external electronic device 400; and/or a function of deleting data (e.g., emoticons) relating to messages that have been previously exchanged between the electronic device 500 and the external electronic device 400.

According to certain embodiments, in operation 1220, the electronic device 500 may identify whether the electronic device 500 supports a specific function.

According to certain embodiments, the electronic device 500 may receive a second message and parse the received second message. The electronic device 500 may extract identification information of a specific function, identification information of a first message related to the specific function, at least a part of the first message, and/or input data through parsing of the second message. A delimiter predetermined between the electronic device 500 and the external electronic device 400 may exist between at least a part of the first message and the input data.

According to certain embodiments, the electronic device 500 may identify whether the electronic device 500 supports a specific function based on identification information of a specific function. According to an embodiment, the electronic device 500 may identify whether the electronic device 500 supports a specific function, based on data, in which a specific function related to an RCS message service supported by the electronic device 500 is stored, and identification information of a specific function stored in the second message.

According to certain embodiments, in a case where the electronic device 500 supports a specific function (operation 1220-YES), the electronic device 500 may identify the first message based on identification information of the first message included in the second message, in operation 1230.

According to certain embodiments, in operation 1240, the electronic device 500 may display together the identified first message and the data included in the second message.

According to certain embodiments, in response to identifying that the electronic device 500 supports a specific function, the electronic device 500 may identify the first message stored in a memory 510 based on identification information of the first message included in the second message. The electronic device 500 may process the second message in a manner of displaying together the identified first message and data included in the second message. The electronic device 500 may distinguish data included in the second message and at least a part of the first message based on a delimiter included in the second message, and may display together the first message stored in the memory 510 and the distinguished data.

According to an embodiment, when a specific function is a function of replying to the first message, the electronic device 500 may identify, in the second message, identification information of the specific function corresponding to the reply function. The electronic device 500 may identify the identification information of the first message included in the second message, and may display together the first message and data in the second message such that the data in the second message is displayed in the form of a reply to the first message.

According to an embodiment, when a specific function is a function of transmitting a designated emoticon of the first message, the electronic device 500 may identify, in the second message, identification information of the specific function corresponding to the emoticon transmission function. The electronic device 500 may identify information indicating an emoticon from data in the second message, and display the identified emoticon together with the first message.

According to an embodiment, when a specific function is a function of sharing the first message, the electronic device 500 may identify, in the second message, identification information of the specific function corresponding to the sharing function. The electronic device 500 may identify, from data in the second message, an address for receiving the first message, and may receive the first message based on the address. The electronic device 500 may display the received first message.

According to certain embodiments, in a case where the electronic device 500 does not support a specific function (operation 1220-NO), the electronic device 500 may display together at least a part of the first message and data, which are included in the second message, in operation 1250.

According to an embodiment, when a specific function is a function of replying to the first message, the electronic device 500 may identify, in the second message, identification information of the specific function corresponding to the reply function. In response to identifying that the second electronic device 500 does not support the identified function, the electronic device 500 may display together at least a part of the first message and data, which are included in the second message.

According to an embodiment, when a specific function is a function of transmitting a designated emoticon of the first message, the electronic device 500 may identify identification information of the specific function corresponding to the emoticon transmission function in the second message. In response to identifying that the second electronic device 500 does not support the identified function, the electronic device 500 may display together at least a part of the first message and data (e.g., information indicating that a user of the first electronic device 400 has added an emoticon to the first message), which are included in the second message.

According to an embodiment, when a specific function is a function of sharing the first message, the electronic device 500 may identify, in the second message, identification information of the specific function corresponding to the sharing function. In response to identifying that the second electronic device 500 does not support the identified function, the electronic device 500 may display together at least a part of the first message (e.g., a part of the first message to be shared) included in the second message and data included in the second message.

An operation method of an electronic device according to certain embodiments may include: performing a registration procedure with a rich communication service (RCS) server; receiving a user input for activating a specific function of a message exchanged with an external electronic device; generating a second message including identification information of the specific function, identification information of a first message related to the specific function, at least a part of the first message, and/or input data; and transmitting the second message to an external electronic device through the RCS server.

In an operation method of an electronic device according to certain embodiments, the generating of the second message may include generating the second message without identifying whether the external electronic device supports the specific function.

In an operation method of an electronic device according to certain embodiments, the generating of the second message may include; identifying the size of the first message; and in response to the size of the first message being equal to or larger than the designated size, adding at least a part extracted from the first message to the second message.

In an operation method of an electronic device according to certain embodiments, the specific function may include a function of replying to the first message, and the generating of the second message may include generating a second message including at least a part of the first message and data corresponding to a user input relating to the first message.

In an operation method of an electronic device according to certain embodiments, the specific function may include a function of displaying a designated emoticon of the first message, and the generating of the second message may include generating the second message including at least a part of the first message and information indicating the emoticon.

In an operation method of an electronic device according to certain embodiments, the specific function may include a function of sharing a message stored in the electronic device, and the generating of the second message may include: uploading the stored message to an external server; and generating the second message including an address on the external server, which corresponds to the uploaded message.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with certain embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStoreTM), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities, and some of the multiple entities may be separately disposed in different components. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a memory configured to store one or more first messages exchanged with an external electronic device;
a wireless communication circuit; and
a processor,
wherein the processor is configured to:
register with a rich communication service (RCS) server;
receive a user input activating a specific function related to a particular one of the one or more first messages;
generate a second message including identification information of the specific function, identification information of the particular one of the one or more first messages, at least a part of the particular one of the one or more first messages, and input data; and
transmit the second message to the external electronic device through the RCS server.

2. The electronic device of claim 1, wherein the processor is configured to generate the second message when the external electronic device does not support the specific function.

3. The electronic device of claim 1, wherein the identification information identifies a particular one of one or more first messages stored in both the electronic device and the external electronic device.

4. The electronic device of claim 1, wherein the processor is configured to:
identify a size of the particular one of the one or more first messages; and
in response to the size of the particular one of the one or more first messages being equal to or larger than a designated size, add at least the part extracted from the particular one of the one or more first messages to the second message.

5. The electronic device of claim 1, wherein the specific function includes a function of replying, and
wherein the processor is configured to transmit the second message including at least the part of the particular one of the one or more first messages and data corresponding to the user input relating to the particular one of the one or more first messages.

6. The electronic device of claim 1, wherein the specific function includes a function of displaying a designated emoticon of the particular one of the one or more first messages, and
wherein the processor is configured to transmit the second message including at least the part of the particular one of the one or more first messages and information indicating the emoticon.

7. The electronic device of claim 1, wherein the specific function includes a function of sharing a message stored in the electronic device, and
wherein the processor is configured to:
upload the stored message to an external server; and
transmit the second message including an address on the external server, which corresponds to the uploaded message.

8. An electronic device comprising:
a memory configured to store at least one first message exchanged with an external electronic device;
a wireless communication circuit; and
a processor,
wherein the processor is configured to:
register with a rich communication service (RCS) server;
receive a second message including identification information of a specific function, identification information of a particular one of the at least one first message, at least part of the first message and data;
in response to identifying that the electronic device supports the specific function based on the identification information of the specific function, identify the particular one of the at least one first message stored in the memory based on the identification information of the particular one of the at least one first message; and
process the second message to display the identified first message and the data together.

9. The electronic device of claim 8, wherein, in response to identifying that the electronic device does not support the specific function based on the identification information of the specific function, the processor is configured to process the second message to display together at least the part of the particular one of the at least one first message and the data included in the second message.

10. The electronic device of claim 8, wherein the processor is configured to:
identify a delimiter between at least the part of the particular one of the at least one first message and the data;
in response to identifying that the electronic device supports the specific function based on the identification information of the specific function, extract the data based on the delimiter; and
process the second message to display the particular one of the at least one first message stored in the memory and the extracted data together.

11. The electronic device of claim 10, wherein, in response to identifying that the electronic device does not support the specific function based on the identification information of the specific function, the processor is configured to process the second message to display together at least the part of the particular one of the at least one first message, the delimiter, and the data.

12. The electronic device of claim 10, wherein the specific function includes a function of displaying a designated emoticon of the particular one of the at least one first message, and
wherein the processor is configured to:
display an emoticon corresponding to the extracted data together with the particular one of the at least one first message stored in the memory, or
terminate displaying of the emoticon according to reception of the second message indicating a function of canceling the displaying of the emoticon.

13. The electronic device of claim 8, wherein the specific function includes a function of sharing a message stored in the external electronic device, and
wherein the processor is configured to:
receive the second message including an address on an external server, which corresponds to the message to be shared;
receive the message to be shared, based on the address on the external server; and
display the message to be shared.

14. The electronic device of claim 8, wherein the particular one of the at least one first message is stored in both the electronic device and the external electronic device.

15. An operation method of an electronic device, the operation method comprising:
registering with a rich communication service (RCS) server;
receiving a user input for activating a specific function related to a message exchanged with an external electronic device;
generating a second message including identification information of the specific function, identification information of a particular one of the one or more first messages related to the specific function, at least a part of the particular one of the one or more first messages, and input data; and
transmitting the second message to the external electronic device through the RCS server.

16. The operation method of claim 15, wherein the generating of the second message comprises generating the second message without identifying whether the external electronic device supports the specific function.

17. The operation method of claim 15, wherein the generating of the second message comprises:
identifying a size of the particular one of the one or more first messages; and
in response to the size of the particular one of the one or more first messages being equal to or larger than a designated size, adding at least the part extracted from the particular one of the one or more first messages to the second message.

18. The operation method of claim 15, wherein the specific function includes a function of replying to the particular one of the one or more first messages, and
wherein the generating of the second message comprises generating a second message including at least the part of the particular one of the one or more first messages and data corresponding to the user input relating to the particular one of the one or more first messages.

19. The operation method of claim 15, wherein the specific function includes a function of displaying a designated emoticon of the particular one of the one or more first messages, and
wherein the generating of the second message comprises generating the second message including at least the part of the particular one of the one or more first messages and information indicating the emoticon.

20. The operation method of claim 15, wherein the specific function includes a function of sharing a message stored in the electronic device, and
wherein the generating of the second message comprises:
uploading the stored message to an external server; and
generating the second message including an address on the external server, which corresponds to the uploaded message.
